(19) United States
(12) Patent Application Publication
(10) Pub. No.: US 2013/0152591 A1
(43) Pub. Date: Jun. 20, 2013

(54) SYSTEM OF INTEGRATING BAFFLES FOR ENHANCED COOLING OF CMC LINERS

(71) Applicant: GENERAL ELECTRIC COMPANY, Schenectady, NY (US)

(72) Inventors: Bryan Robert Dery, Mason, OH (US); Scott Matthew Bush, Liberty Township, OH (US); Donald Michael Corsmeier, West Chester, OH (US)

(73) Assignee: GENERAL ELECTRIC COMPANY, Schenectady, NY (US)

(21) Appl. No.: 13/628,430

(22) Filed: Sep. 27, 2012

Related U.S. Application Data
(60) Provisional application No. 61/576,880, filed on Dec. 16, 2011.

(51) Int. Cl. F23R 3/50; F02C 7/18

(52) U.S. Cl. 60/753; 60/754

(57) ABSTRACT

A system of integrating baffles for enhanced cooling of CMC liners is comprised of a combustor assembly having a dome mount assembly, outer liner and inner liner. Liners include those manufactured from and in a process for CMC (Ceramic Matrix Composite). One or more liner baffles such as outer baffle and inner baffle, are provided to reduce the pressure drop across the liner, allowing the addition of more cooling holes and thereby reducing the cooling hole spacing while not increasing the required amount of cooling air. CMC liners are incorporated, as desired, to take advantage of shapes and hole dispositions made possible by use of CMC over past designs.

### CROSS REFERENCE TO RELATED APPLICATION

This application claims the benefit of U.S. Provisional Application No. 61/576,880, filed Dec. 16, 2011, which is incorporated by reference in its entirety.

### BRIEF DESCRIPTION OF THE DRAWINGS

FIG. 1 is a cross sectional illustration of an aviation gas turbine engine.

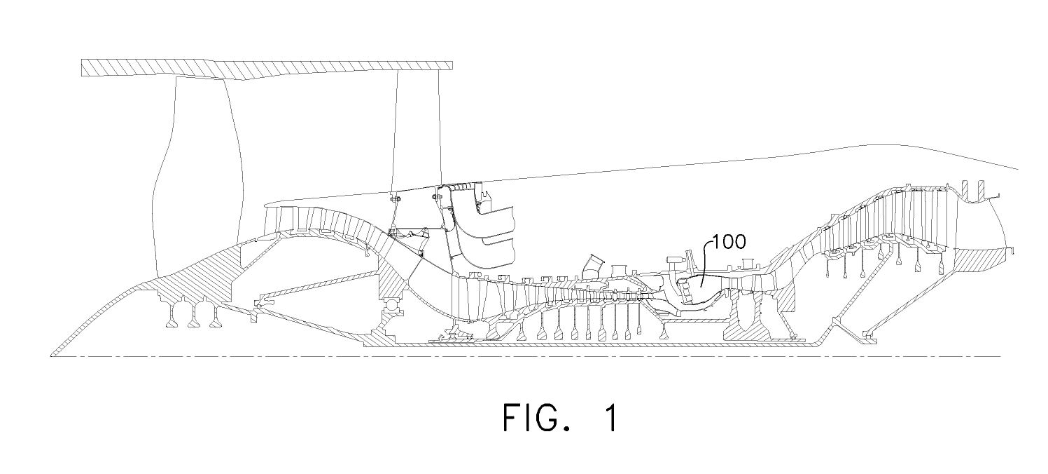

FIG. 2 is a cross sectional illustration showing selected features of a system of integrating baffles for enhanced cooling of CMC liners.

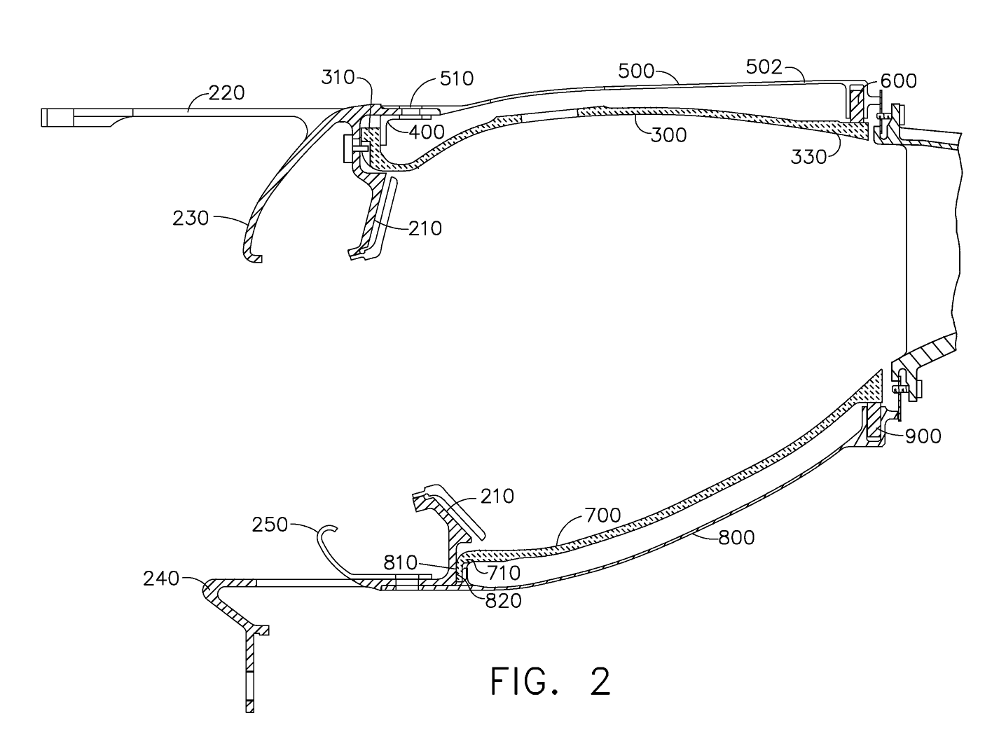

FIG. 3 shows selected details of the system of FIG. 2.

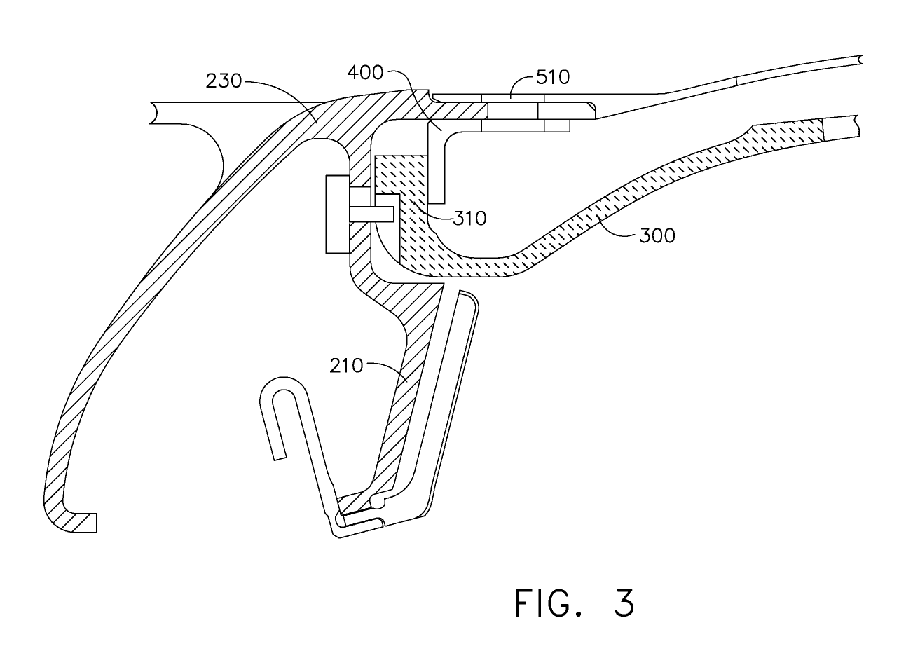

FIG. 4 shows further details of the system of FIG. 2.

FIG. 5 shows details for an impingement jacket as a component of a system of integrating baffles for enhanced cooling of CMC liners.

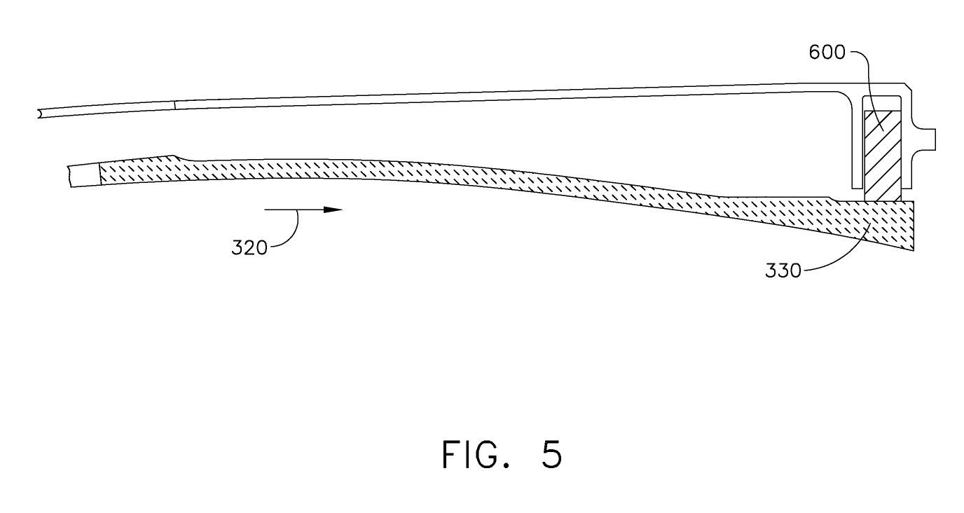

FIG. 6 shows details for an alternative impingement jacket as a component of a system of integrating baffles for enhanced cooling of CMC liners.

FIG. 7 shows details regarding the orientation of CMC liner flanges.

FIG. 8 shows details for an alternative embodiment being a system for enhanced cooling of CMC liners wherein a combustor liner provides a direct sealing interface with a turbine nozzle.

### BACKGROUND AND PROBLEM SOLVED

Gas turbine engines feature combustors as components. Air enters the engine and passes through a compressor. The compressed air is routed through one or more combustors. Within a combustor are one or more nozzles that serve to introduce fuel into a stream of air passing through the combustor. Igniters are typically used to ignite the resulting air-fuel mixture within the combustor. The burned air-fuel mixture is routed out of the combustor and on through a turbine to exert forces upon turbine blades and do work in causing the engine to spin thereby creating power.

Turbine engine operators desire high efficiency while also achieving low emissions. Focusing on combustors as a source of emissions, a problem to be solved with low emissions combustors is that more and more air is being used for combustion to lower NOx, which results in less air being available for cooling.

Traditionally, effusion hole film cooling has been utilized in efforts to reduce the amount of air required for cooling. However traditional effusion hole film cooling has not been practical in cases where hole-to-hole spacing becomes too large, resulting in the occurrence of undesirable hot streaks between holes. Embodiments are provided that solve this problem by integrating baffles for enhanced cooling of CMC combustor liners. Alternative embodiments solve his problem by providing a baffle that makes optimized use of available cooling air by reducing a liner cooling feed pressure such that a more densely configured cooling pattern may be employed, thereby leading to better film effectiveness and reduced gas surface temperatures on a CMC liner.

Furthermore, a problem regarding CMC liners in past configurations is that there is a combustor support on a liner forward end and a seal housing support on a liner aft end. As a result, air flowing through both inner and outer passages is interrupted twice; a first interruption due to presence of the combustor support and a second interruption due to the seal housing support. The result of these interruptions is undesirable aerodynamic wakes and associated losses in operational efficiency.

Embodiments of baffles solve this problem by integrating the baffles into the seal housing supports, thereby eliminating the second interruption and its contribution to any aerodynamic wakes and losses in efficiency.

In contrast to the present embodiments, CMC combustor liners in the past have not employed baffles. Instead, they utilized densely populated cooling hole patterns and required significantly more cooling air than what is required by embodiments and alternatives provided herein.

Embodiments allow employment of a more densely populated cooling pattern, which lowers CMC liner gas side surface temperatures. As a result, CMC liner durability is significantly increased to meet product type requirements given the limited amount of cooling air.

Embodiments further allow that the baffles are incorporated, as desired, into a support for a piston ring seal housing, which reduces the total weight of the combustor system. Alternatives decrease part count over existing systems, thereby providing reduced costs and time in manufacture. Lower weight also leads to improved specific fuel consumption (SFC) and reduced operating cost.

Embodiments of a baffled CMC liner provide that the baffles are shaped, as desired, such that they reduce and/or eliminate aerodynamic wakes and losses caused by the CMC liner flanges. By reducing losses in the passages, cooling air can be delivered at higher pressures and at better back flow margins to downstream hardware, thereby providing enhanced durability for associated turbine component designs.

Alternative baffles direct backside cooling air as required to increase backside heat transfer coefficients. Such increases to heat transfer coefficient result in lower operating temperatures and the potential for reduced stresses in components, both resulting in improvements to CMC liner durability.

Embodiments of baffles provide radiation heat shielding to surrounding structures, thereby allowing those structures to experience cooler temperatures in operation. As such, surrounding structures may be manufactured from materials and design selected to optimize their operation at reduced temperatures over past designs, thereby resulting in more efficiency and reduced costs than before. In addition, cooler temperatures can lead to reduced overhaul costs and less frequent overhaul and/or replacement of associated structures.

### MULTIPLE EMBODIMENTS AND ALTERNATIVES

A system of integrating baffles for enhanced cooling of CMC liners is comprised of a combustor assembly 100 having a dome mount assembly 200, outer liner 300 and inner liner 700. Liners 300, 700 include those manufactured from and in a process for CMC (Ceramic Matrix Composite). One or more liner baffles such as outer baffle 500 and inner baffle 800, are provided to reduce the pressure drop across the liner 300, 700, allowing the addition of more cooling holes and thereby reducing the cooling hole spacing while not increasing the required amount of cooling air. CMC liners 300, 700 are incorporated, as desired, to take advantage of shapes and hole dispositions made possible by use of CMC over past designs.

### DESCRIPTION OF THE EMBODIMENTS

The liner baffles 500, 800 are constructed, as desired, from materials to include a high temperature super alloy, Oxide CMC, or SiCSiC CMC depending on the mission, configuration, interfaces, and other designs.

Embodiments of baffles 500, 800 allow for increased effusion hole film cooling effectiveness given a fixed amount of cooling air. This overcomes a difficulty in trying to cool CMC combustor liners in that the material has a relatively low conductivity, such that the predominant means of effective cooling is via effusion film cooling. In detail, a problem with simply swapping in a cooling pattern from a metal liner to a CMC liner is that the CMC liner 300, 700, without a baffle 500, 800 would utilize the same amount of cooling, negating the potential benefit of the CMC. The baffle 500, 800 works by controlling the amount of pressure loss across it by means of holes or cut outs in the baffle 500, 800. The liner 300, 700 cooling feed pressure is then reduced to a certain value such that effective cooling is achieved on the hot side of the liner 300, 700 by means of effusion film cooling with tighter hole spacing than can be achieved with the same amount of air. Namely, film cooling effectiveness is increased with a baffle 500, 800 for a given amount of cooling air.

Embodiments of baffles 500, 800 are incorporated to support an outer baffle piston ring seal housing 530 and an inner baffle seal housing 840 along with an outer piston ring seal 600 and an inner piston ring seal 900. Alternatives provide a baffle 500, 800 is fixed at one end of the liner and is free to float at the other due to the alpha miss-match between CMC and metal. Alternatives include those wherein the baffles are sealed at neither, either or both ends, as desired.

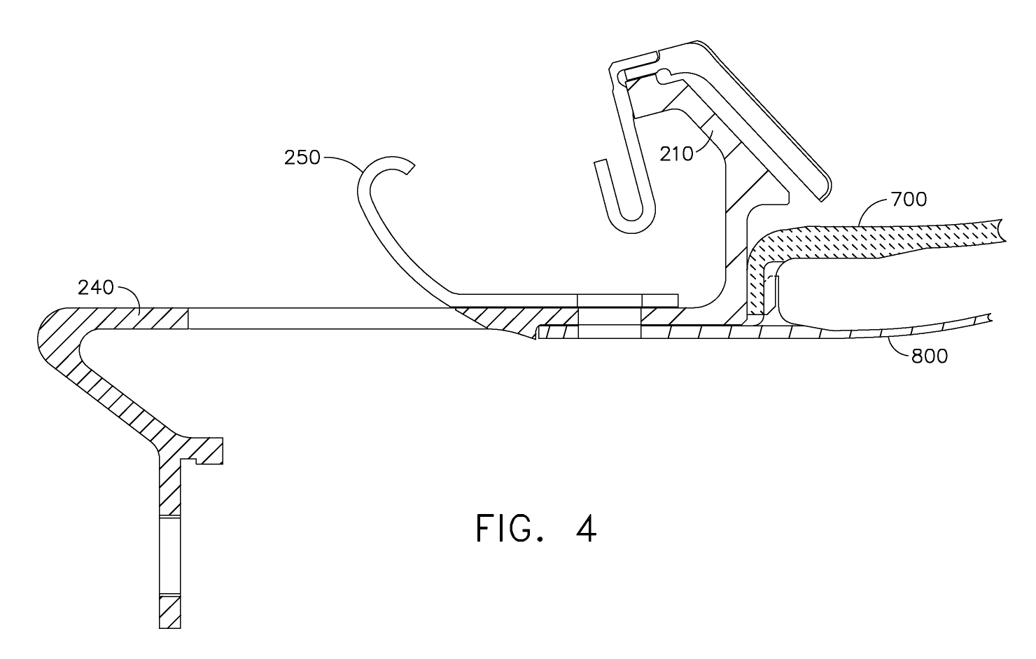

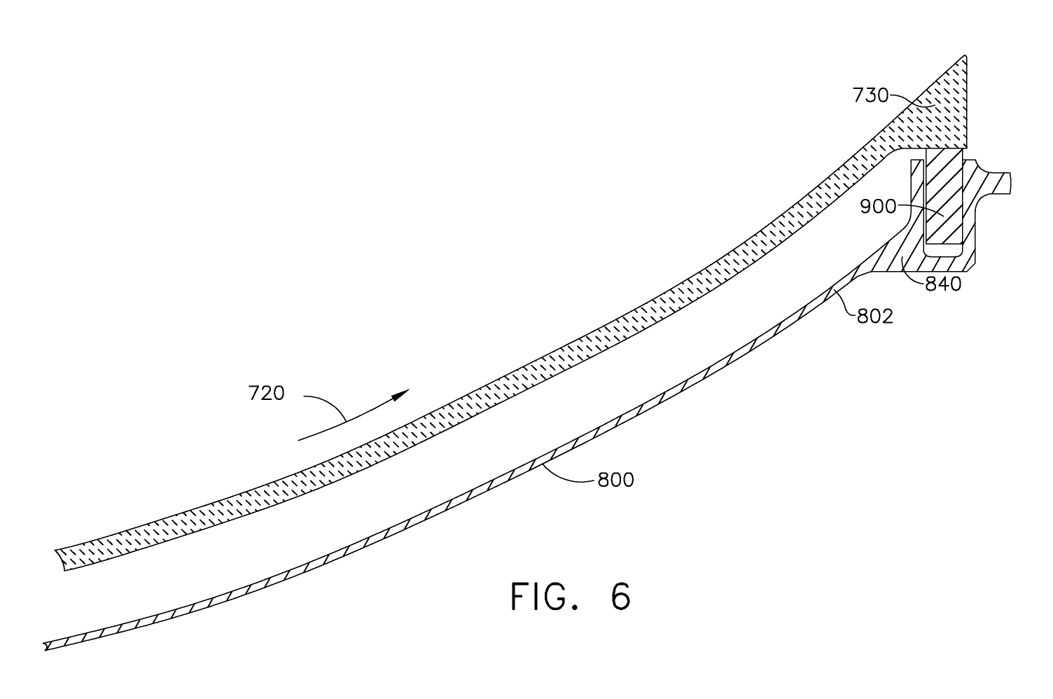

With reference to FIG. 4, the inner baffle 800 is bolted at a forward end being forward mount 810 to the dome plate 210 and allowed to remain free at an aft end 802 (See FIG. 6). An alternative provides that the baffle 800 is incorporated into the piston ring seal housing 840 thereby providing seal housing support 830 that supports the seal housing 840, which in turn captures the piston ring seal 900.

Integrating the support seal housing support 830 into the baffle 800 also decreases parts count and cost.

Baffle embodiments provide a means to control aerodynamic wakes and losses around CMC liner flanges, such as for example, outer liner forward mount flange 310 and inner liner forward mount flange 710 thereby improving downstream feed pressure uniformity and decreasing the risk of local backflow.

As desired, the baffle 500, 800 is shaped such that it provides a clean aerodynamic shape to eliminate or reduce large aerodynamic wakes and subsequent losses as gases are routed to pass by the outboard turned liner flanges 310, 710 thereby solving a problem associated with non-baffle designs that had large wakes, resulting in negative axial flow in the inner passage, and avoiding detrimental aspects of such a flow field that could otherwise result in lower cooling feed pressures for downstream hardware, namely the Combustor liners, Stage 1 HPT Nozzle, Blade, and Shroud.

Baffle embodiments are used to increase CMC liner backside cooling effectiveness. For example, holes and/or cut outs in the baffle surfaces are formed, as desired, as openings disposed upon an outer baffle flow restrictor 520 and to incorporate an inner baffle flow restrictor 830 into the inner baffle 800. These openings allow air to pass through while providing a controlled pressure drop to the liner cooling feed pressure and they are provided such that they allow this same air to scrub, impinge, or otherwise flow over the liner 300, 700 such that the CMC liner cold side heat transfer coefficient is increased. A higher back side heat transfer coefficient results in more heat being pulled out of the CMC, which leads to lower CMC liner operating temperatures, decreased bulk thermal tresses, and improved durability.

Providing radiation heat transfer from the liners 300, 700 to the surrounding structure is an undesired characteristic of CMC liners as they tend to operate at higher temperatures than their metallic counterparts. The liner baffles 500, 800 therefore provide enhanced radiation heat shielding for the structure surrounding the combustor assembly 100. As such, alternative embodiments provide baffles 500, 800 that are formed and disposed to shield the case, and the Forward Inner Nozzle Support (FINS) from both the outer liner 300 and the inner liner 700, respectively.

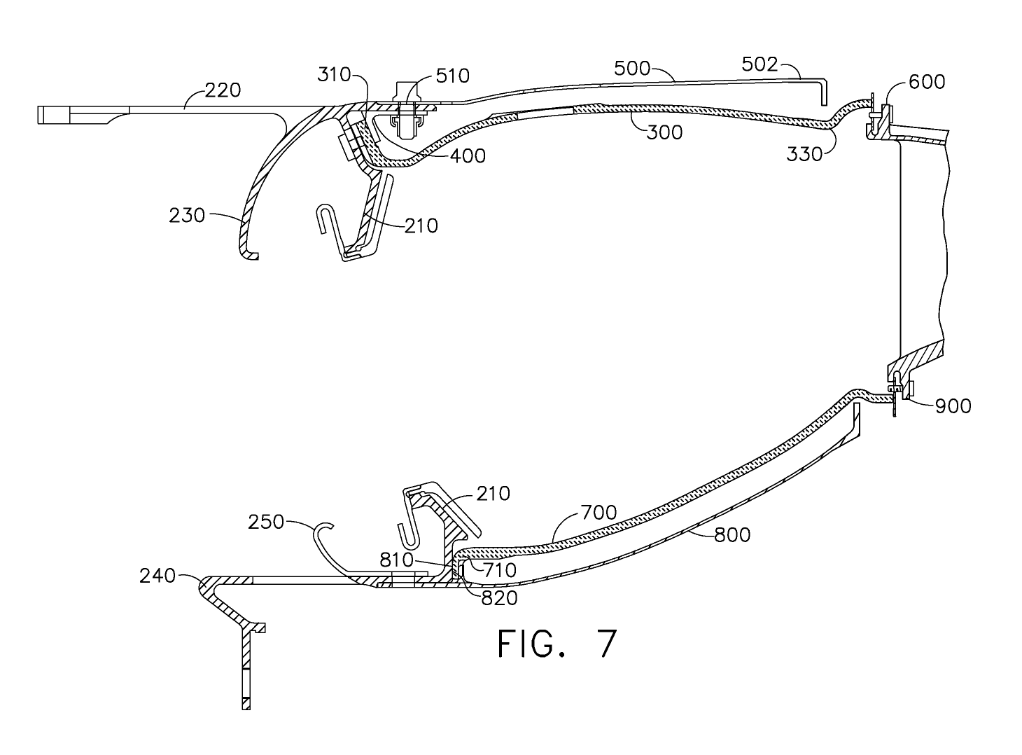

As shown in FIG. 7, the orientation of the CMC liner flanges may be in a pure radial orientation with respect to the core of the engine, or alternatively, at a selected conical angle, chosen by a user.

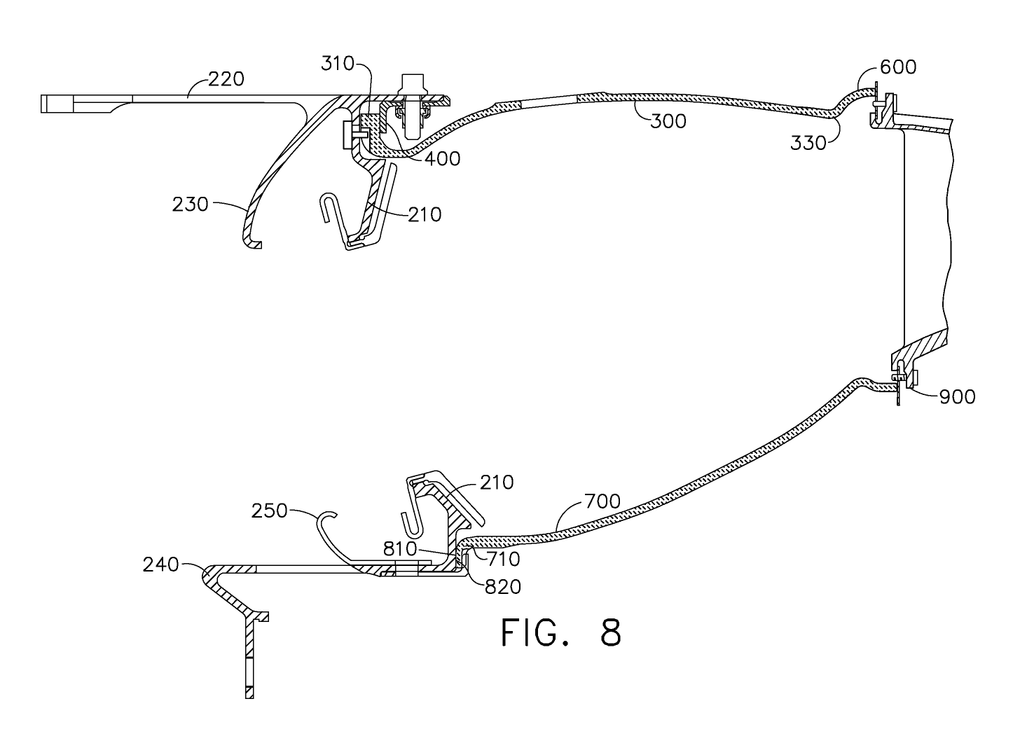

As shown in FIG. 8, alternative embodiments include those wherein no baffles are used. In such embodiments, a system for enhanced cooling of CMC liners is provided comprising CMC combustor liners 300, 700 with CMC liner flanges 310, 710 coupled with a dome plate 210, liner retainers 400, 820 and seals 600, 900 wherein the combustor liners 300, 700 provide a direct sealing interface with a turbine nozzle.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

1. A system of integrating baffles for enhanced cooling of CMC liners comprising CMC combustor liners with CMC liner flanges, coupled with one or more baffles each having a forward end and an aft end.

2. The system of claim 1 wherein the baffles are not sealed at either end.

3. The system of claim 1 wherein the baffles are sealed at only one end of each baffle.

4. The system of claim 1 wherein the baffles are sealed at both ends.

5. The system of claim 1 wherein an inner baffle is bolted at a forward end, that end being a forward mount to a dome plate and allowed to remain free at an aft end.

6. The system of claim 5 wherein the baffle is incorporated into the piston ring seal housing thereby providing seal housing support that supports a seal housing, which in turn captures a piston ring seal.

7. The system of claim 1 wherein the baffle aft ends have piston ring housings and piston ring seals formed thereupon.

8. The System of claim 6 further comprising liner retainers and seals.

9. The system of claim 1 further comprising the CMC liner flanges oriented from the group consisting pure radially, selected conical angle.

10. A system of integrating baffles for enhanced cooling of CMC liners comprising CMC combustor liners with CMC liner flanges, coupled with one or more baffles each having a forward end and an aft end, the baffle aft ends having piston ring housings and piston ring seals formed thereupon, a dome plate, liner retainers, and seals.

11. The system of claim 10 wherein the baffles are not sealed at either end.

12. The system of claim 10 wherein the baffles are sealed at only one end of each baffle.

13. The system of claim 10 wherein the baffles are sealed at both ends.

14. The system of claim 10 wherein an inner baffle is bolted at the forward end, that end being a forward mount to the dome plate and allowed to remain free at the aft end.

15. The system of claim 10 wherein the baffle is incorporated into the piston ring seal housing thereby providing a seal housing support that supports the seal housing, which in turn captures the piston ring seal.

16. The system of claim 10 further comprising the CMC liner flanges oriented from the group consisting pure radially, selected conical angle.

17. The system of claim 10 wherein the baffle aft ends have piston ring housings and piston ring seals formed thereupon.

18. A system for enhanced cooling of CMC liners comprising CMC combustor liners with CMC liner flanges, coupled with a dome plate, liner retainers, and seals and no baffles.

19. The system of claim 18 wherein the combustor liner provides a direct sealing interface with a turbine nozzle.

20. A system for enhanced cooling of CMC liners comprising CMC combustor liners with CMC liner flanges, coupled with a dome plate, liner retainers, and seals and no baffles wherein the combustor liner provides a direct sealing interface with as turbine nozzle.
